(19) United States
(12) Patent Application Publication
(10) Pub. No.: US 2002/0035801 A1
(43) Pub. Date: Mar. 28, 2002

(54) Method of trapping mice

(76) Inventor: Rikio Ogura, Ikoma-shi (JP)

Correspondence Address: EVENSON, McKEOWN, EDWARDS & LENAHAN, P.L.L.C., Suite 700, 1200 G Street, N. W., Washington, DC, 20005, US

(21) Appl. No.: 09/854,914

(22) Filed: May 15, 2001

(30) Foreign Application Priority Data
May 15, 2000 (JP) JP 00-141781

(51) Int. Cl. A01M 23/02; A01M 23/16; A01M 23/32

(52) U.S. Cl. 43/61

(57) ABSTRACT

A method for capturing mice with a baited cage incorporating a trigger mechanism whereby the mice are confined in the cage, characterized in that the trigger mechanism is kept inoperative for some time so as to allow a mouse to go on eating the bait, which is supplemented if it is short, eventually the mouse coming to feel as if the cage is its own home and forgets that it is a trap. The happy mouse allures its relatives and friends to the baited cages. It is at this stage when the trigger mechanism is set off to confine them in the cages.

### BACKGROUND OF THE INVENTION

This application claims the priority of Japanese application 00-141781, filed May 15, 2000, the disclosure of which is expressly incorporated by reference herein.

The present invention relates to a method for trapping rodents and, in particular, house mice with baited cages.

To capture house mice, many methods employing various kinds of devices are in use. An example using a chemical substance is disclosed in Japanese Patent Application Kokai No. 10-327734, and another using ultrasonic waves is disclosed in Japanese Patent Application Kokai No. 7-107893. One using a mousetrap is disclosed in Japanese Patent Publication No. 63-31587 (allowed). The first-mentioned method using a chemical substance is likely to do harm to human beings. The second-mentioned method using ultrasonic waves has a disadvantage due to its limited reach of ultrasonic waves, and another disadvantage is in that the ultrasonic waves constantly emitted prevents the escaped mice from coming back to their abodes or homes.

As compared with the first-mentioned two methods, the last-mentioned method may be safer and more sanitary. The known mouse trapping devices are to capture mice alive, and they are killed later by a separate method. To do so, bait and a trigger mechanism are a key point. Normally, the baited cage is fitted with a board on which a mouse steps, wherein the board is connected to the trigger mechanism. In response to the movement of the board caused by the mouse, the trigger is set off to close the cage. Another type has a cage provided with a pathway converging inward so as to allure a companion of a trapped mouse to follow it into the cage through the pathway. However, the mouse is wise enough to recognize the trap and avoid approaching it.

There is another type of trap which is equipped with a door mechanically triggered in response to a mouse entering the cage, which, for example, is disclosed in Japanese Utility Model Publication No. 63-31587 (allowed). However, a mouse may be suspicious and too prudent to enter the baited cage. Therefore, to solve this difficulty, there is a proposal for keeping the cage open and allowing the mice to go on eating the bait until they come to feel as if the baited cage is their home or abode, and lose their suspicion.

The present invention is based on the discovery that once mice are captured in a cage, uncaptured mice are wise enough to know that the baited cage is a trap, and the information runs to their companions. There is a proposal for a baited cage of the type which can keep the trigger mechanism inoperative for several days and allow the mice to go on eating the bait until they come to feel as if the cage is their home, but a problem is how to make up for shortage of bait while the door is kept open. Another problem is how to timely set off the trigger mechanism. Under such circumstances it is very difficult to capture a nest of mice at one time.

A primary object of the present invention is to provide a method of efficiently capturing a nest of mice living at a particular place.

### SUMMARY OF THE INVENTION

The present invention is based upon the discovery that if a mouse having entered the baited cage is allowed to go on eating the bait without setting off the trigger mechanism, eventually the mouse feels as if the cage is its own home, and it returns to the cage with other mice. In this way when the cage is full of mice, the door is triggered to confine them in the cage.

According to one aspect of the invention, the method of capturing mice includes the steps (1) to (4). These steps are described below.

(1) The First Step

A baited cage is placed in place with the pathway being kept open even if the bait is eaten by a mouse entering the cage.

The location of the baited cage is decided in accordance with data obtained through research about a route which mice like to take, a popular bait among mice, and an efficient type of cage, so as to enhance the capturing efficiency. Efficient types of traps are determined as a result of a series of experiments in which different trapping devices and bait are used.

(2) The Second Step

An additional cage having a similar structure to that used in the first step is placed with the trigger mechanism kept inoperative irrespective of the mouse eating the bait, wherein the device and the bait are selected in accordance with experience obtained from the first step.

The method according to the present invention is distinguished from known mouse traps, in that the mice having entered the cage are kept fed with bait without closing the door so that they feel as if the cage is their own home, and invite their companions to the cage. In this way a plurality of mice may be allured into the cage, thereby resulting in a mass-capture of mice.

(3) The Third Step

The second step is continued for a predetermined time, and the ratio of used cages whose bait is eaten (B) to the ones initially set (A) (hereinafter referred to as ‘unused cage’) is calculated. If it exceeds a predetermined value, the doors of the used cages are made closable on and from the day when the ratio has reached the predetermined value so that the mice are confined in the cage as captives.

The ratio of B to A (where (B) is the number of used cages confining a captive, and (A) is that of initially set cages) depends upon not only the number of mice living in and around the surroundings in which the cages are set, but also the number of cages set therein. The ratio differs with the numbers of mice and cages. For example, if 20 baited cages are set at a place where 10 mice live, and each mouse eats the bait from cage to cage, the ratio of B to A will be equal to 1 to 2; that is, 50% even if all the mice eat the bait placed in all the cages. In this situation, 10 cages will suffice in anticipation of B to A being 100%. The B to A ratio is decided by estimating the number of mice living at the place where the cage is set, and deciding the number of cages to be set in accordance with the estimated number of mice. For example, when a single cage is allocated to one mouse living at the cage setting place (B to A=1 to 1), the B to A is preferably 1 to 2 and more preferably 3 to 4. Normally, a mouse tends to monopolize bait of a particular cage, and therefore, the number of cages to be set is increased in accordance with an increase in the number of target mice. Ideally, the ratio 1 to 1 (i.e. 100%) is desirable where all the mice can be captured at one time. Actually, however, it often happens that more than one mouse eats the bait of one cage, which means that the ratio 1 to 1 is not reached on the day when all the mice have eaten the respective bait. Therefore, the ratio 1 to 1 is a prima facie standard presuming that target mice come and eat the bait in the cages. If two cages are set for a single mouse, the ratio will be halved.

In the third step the trigger mechanism is made operative for all the cages on the day when the ratio B to A has reached a predetermined value, or if it is desired, a few days later therefrom. This timely switching-over of the trigger mechanism of the baited cages is necessary for capturing as many mice as possible at one time. An important thing is to confirm that no mouse appears around the baited cage. However, it is preferred that the trigger mechanism should be set a few more days later, because temporarily migrating mice may come back to their old homes in search for bait.

(4) The Fourth Step

When the third step is over, all or almost all of the mice are captured, and the surroundings are made free from mice. However, this favorable situation does not last long. In a few days new mice begin to visit, most of which temporarily migrated to escape the capture and return to their homes.

As a solution to the problem pointed above, the fourth step consists of employing several cages having different shapes, and repeating the first step to the third step at least one time (one cycle). The use of different shapes is to confuse the learned mice; if a cage having the same shape is repeatedly used, the learned mice will recognize it as a trap, and will avoid it.

Preferably, the fourth step is practiced a few days later, such as 10-odd days, depending upon an increase or decrease in the number of mice. The frequency of repetition depends upon the degree of damage by mice. If, after the first to third steps are conducted several times, no mouse visits for a pretty long time, this cycle can be repeated three months or half a year later.

The process is performed as described above. Apart from the process, the design of a cage is also important for an efficient capture. For example, care must be taken not to cause the trigger mechanism to set off before a mouse eats the bait or before it feels comfortable in the cage, as if it were home. Another point is that the shutter must be triggered at exactly the right time. A known cage is provided with a pan on which mice step so as to trigger the door, so as to confine them in the cage. However, it often happens that the trigger is erroneously set off in response to a slight movement or swing of the cage. If the trigger mechanism has a poor sensitivity, the cage is closed when no mouse is present in the cage.

To prevent the cage from being closed when no mouse is present, the trigger mechanism shown in FIGS. 1 and 2 is employed.

FIG. 1 shows a trapping device 100 including a cage 1 which is provided with an entrance 9, a shutter 10 rotatable around a pivot 11, and a board 14 adapted for a mouse to ride on, being supported by a horizontally pivot shaft 15 at one side so as to be vertically swingable around the shaft 15. The shutter 10, as its name implies, closes the entrance 9 when it is disengaged with a trigger mechanism and caused to rotate in a clockwise direction by its own weight. A leaf spring 13 is fixed adjacent to the shutter 10, wherein the spring 13 includes a hooked end or trigger 13b and a stationary end 13a where the spring 13 is fixed to the shutter 10 with the trigger 13b being connected to the board 14 by means of a connecting line 17. The trigger 13b is deformed in a direction where it comes into engagement with the shutter 10 by its own weight or in a direction where it is set free from the shutter 10 in response to the movement of the board 14 by a mouse. Thus, the shutter 10 is triggered to close the cage 1.

As described above, the connecting line 17 is connected, preferably in tension, with the trigger 13b at one end, and the board 14 at the other end through a pole 16 erected on the board 14. The line 17 can be made of a chain or a string. The trapping device 100 will be described in detail below.

To keep the cage 1 open, the shutter 10 is raised above the entrance 9 by engaging the trigger 13b with the shutter 10 under the force of the spring 13, which means that the trigger mechanism is kept inoperative. If a mouse entering the cage 1 through the entrance 9 steps on the board 14 or touches the connecting line 17, the trigger 13b of the spring 13 comes out of contact with the shutter 10. Thus the shutter 10 rotates in a clockwise direction around the pivot 11, and closes the entrance 9 with the mouse confined in the cage 1.

The shutter 10 is opened when it comes into engagement with the trigger 13b by the spring 13. The trigger 13b is constantly spring-biased to engage with the shutter 10. As a result, even if the cage 1 is inadvertently shaken or trembled, the shutter 10 remains stationary and the entrance 9 is kept open. Once a mouse has entered the cage 1, and steps on the board 14 or touches the connecting line 17, the shutter 10 is disengaged with the trigger 13b and rotates in a crosswise direction by its own weight. Thus the cage 1 is closed by the shutter 10 with the mouse confined therein. Herein the clockwise and anti-clockwise direction is when viewed from inside the cage as shown in FIG. 1.

According to the present invention, the method of capturing mice is carried out by using the trapping device 100 described above, from the first step to the fourth step. In the first step, a required number of devices 100 are positioned in place, with the entrance 9 kept open. In the second step, the bait in each cage is checked at day intervals to know whether it was eaten. A cage whose bait is diminished is supplemented with fresh bait of the same kind or which is liked by mice. In addition, the surroundings are also inspected to estimate the number of mice living there, by reference to mouse feces scattered about. If the number is found to be more than previously expected, devices of the same type are added so that the mice are fed with the bait until they feel at home in the baited cage. In this way the mice are allured into the cages with no fear about a trap.

In the third step the ratio of B to A is checked to see whether it has reached a predetermined value. If it has reached the predetermined value, the shutters 10 of all the cages 1 are prepared for closure in response to the mice entering the cages 1, so that if a mouse enters the cage, the trigger mechanism is released in response to the movement of the board 14 caused by mice. At this stage it is expected that a pretty large number of mice come to eat the bait, and are held in confinement at one time. In this way, the surroundings may be made free from a mouse problem.

However, a few days later migrating mice come back to their homes and a fresh group joins them. As a result, the original places are again haunted by these visitors.

Therefore, the fourth step is required. The fourth step is the repetition of the first step to the third steps, with the use of different types of trapping devices 100. In this way the fresh gang are captured.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view showing a trigger mechanism used in the trapping device according to the present invention;

FIG. 2 is a vertical sectional side view showing the operation of the trigger mechanism shown in FIG. 1;

FIG. 3 is a front view showing another type of trigger mechanism;

FIG. 4 is a vertical section taken along the A-A line in FIG. 3;

FIG. 5 is a sectional view showing the operation of a further type of trigger mechanism, wherein (a) shows the shutter kept open, (b) shows it in the closing process, and (c) shows it closed;

FIG. 6 is a vertical sectional side view illustrating another modified version of the trigger mechanism used in the present invention;

FIG. 7 is a perspective view showing a trapping device used in the preparatory process;

FIG. 8 is a perspective view showing another trapping device used in the preparatory process, and to be added in the fourth step;

FIG. 9 is a perspective view showing a trapping device used in the second cycle;

FIG. 10 is a perspective view showing a trapping device used in the third cycle;

FIG. 11 is a perspective view showing a trapping device used in the fourth cycle;

FIG. 12 is a chart showing a working process of capturing mice, including a preparatory process, followed in 30 days from the start;

FIG. 13 is a working process of capturing mice followed in 30 to 60 days later from the start;

FIG. 14 is a working process of capturing mice followed in 60 to 90 days later from the start; and

FIG. 15 is a working process of capturing mice followed in 90 to 118 days (on which the process is over) later from the start.

### DETAILED DESCRIPTION OF THE PREFERRED EMBODIMENTS

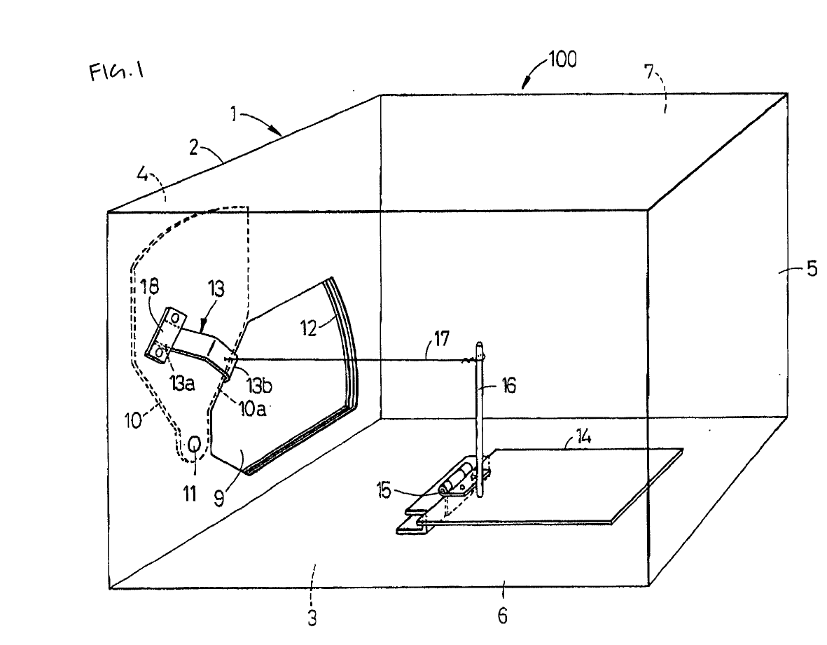

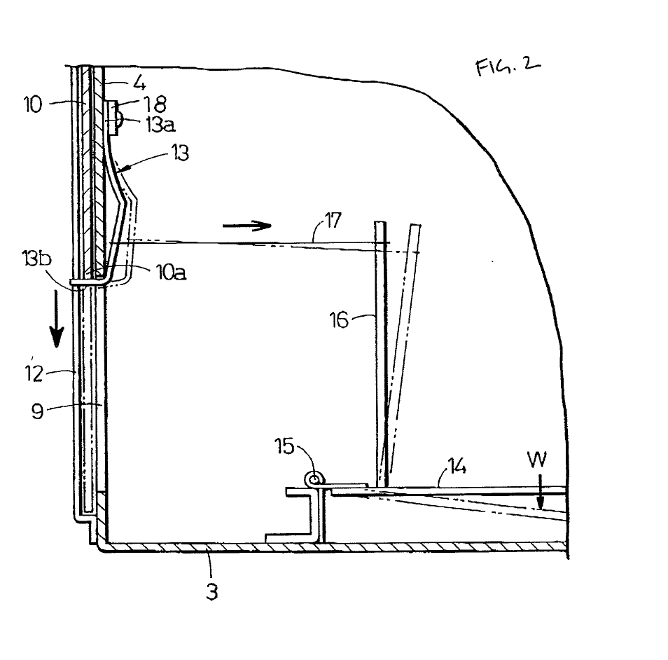

A first embodiment employs any of the trigger mechanism illustrated in FIG. 1 to FIG. 6. First, the basic structure will be described by referring to FIGS. 1 and 2.

The trapping device 100 includes a cage 1 which includes a ceiling 2, a floor 3, and sides 4 to 7, constituting a polygonal casing. It preferably can be made of any of or a combination of metal, metal lattice work, plastics board, wooden board, paper and cloth.

The cage 1 is provided with an entrance 9 through which mice enter the cage, and a shutter 10 for closing entrance 9. The illustrated embodiment has entrance 9 on side 4 (left-side face) and the shutter 10 outside the side 4 provided in such a manner as to allow it to rotate in a clockwise direction along an arc-shaped guide groove 12 around a pivot 11. More specifically, as preferably shown in FIG. 2, the shutter 10 rotates in a clockwise direction by its own weight, thereby closing the entrance 9 (in FIG. 2, the shutter is indicated in dotted line), and in an anti-clockwise direction (in FIG. 2, it is indicated in solid line), thereby opening the entrance 9.

A spring 13, preferably a leaf spring, is provided adjacent to the entrance 9, designed to keep the shutter 10 away from the entrance (the open state). The spring 13 preferably may be made of metal or plastic. Preferably, the spring 13 is provided with a seat 18 where the spring 13 is fixed to the shutter 10, and a base 13a and a trigger 13b, formed by a hooked end of the spring 13, holding the shutter 10 from rotating. The trigger 13b is preferably shaped like the letter L.

The spring 13 constantly urges the trigger 13b to project through the entrance 9, and bring the trigger 13b into engagement with a lower edge 10a of the shutter 10, thereby keeping the cage 1 open. The trigger 13b is disengaged with the lower end 10a when it is pulled against the spring 13, thereby allowing the shutter 10 to rotate in a clockwise direction by its own weight and close the entrance 9. In this way the trigger mechanism is set off.

As shown in FIG. 2, the cage 1 is provided with a board 14 on the floor 3, adapted for a mouse to step on. The board 14 is rotatably fixed at one end and free at the other, and kept horizontal so as to capture rodents of any size, from rats having a weight of 200 to 300 g to young mice having a weight of 15 to 40 g so that when stepped upon, the board 14 declines as indicated in dotted line in FIG. 2.

The board 14 is provided with a pole 16 upright thereon, and is connected to the trigger 13b by means of a line 17 such as a chain or a string through the pole 16. When the board 14 declines, the connecting line 17 is pulled in the direction indicated by the arrow in FIG. 2, thereby disengaging the trigger 13b with the shutter 10. In this way the shutter 10 rotates in a clockwise direction by its own weight.

While the shutter 10 is kept closed, the trigger 10b is kept inoperative by keeping contact with the inner surface of the shutter 10. When the shutter 10 is rotated in an anti-clockwise direction, the trigger 13 restores its engagement with the lower end 10a of the shutter 10, thereby keeping the shutter 10 open. In this way the cage 1 is made ready for mice to eat the bait. The bait should be placed anywhere in the cage except on the board 14.

A mouse enters the cage 1 through the entrance 9 to eat the bait, and steps on the board 14. The board 14 declines around the horizontal shaft 15 under the load (W) of the mouse, thereby disengaging the trigger 13b with the lower end 10a of the shutter 10. Thus the shutter 10 rotates around the pivot 11 in a clockwise direction by its own weight to close the entrance 9 with the mouse confined in the cage 1.

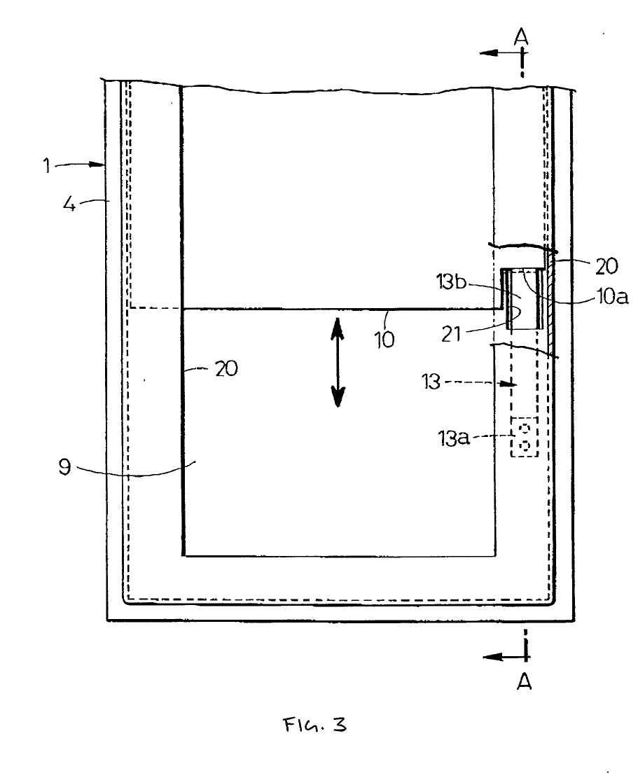

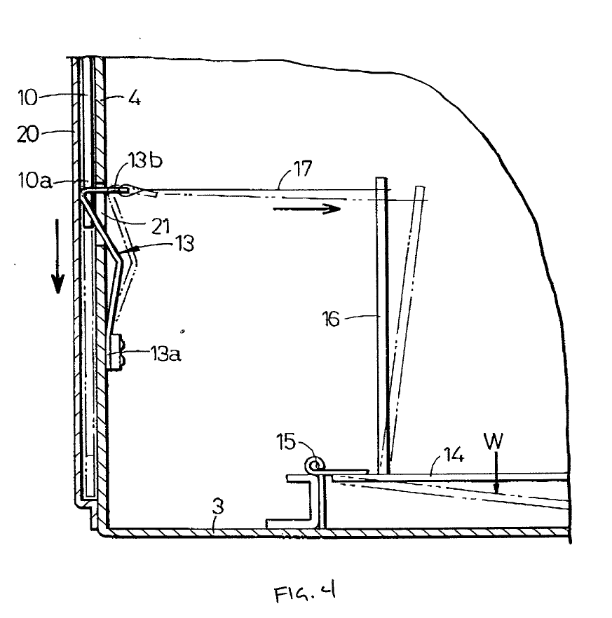

As shown in FIGS. 3 and 4, instead of the structure in which the shutter 10 rotates in a clockwise direction to close the entrance 9, the side 4 of the cage 1 may be provided with a pair of guide grooves 20 in its opposite edges so as to enable the shutter 10 to slide along these grooves. The guide grooves 20 can be vertical or slanted.

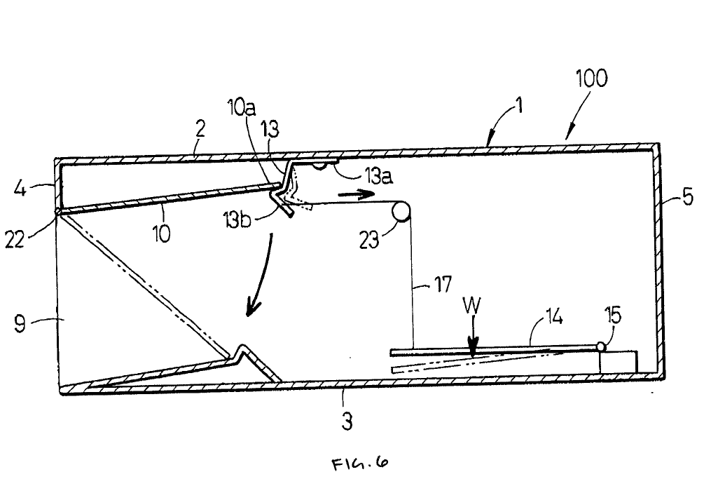

Alternatively, as shown in FIG. 6, the shutter 10 may be rotatably connected to the side 4 of the cage 1 through a pivot 22, wherein a free end 10a thereof is releasably supported by the trigger 13b of the spring 13 connected to the board 14 by the line 17 as described above.

The trigger 13b can be variously shaped; a typical one is L-shaped as shown in FIG. 2, but as shown in FIG. 4 it can be V-shaped, having the trigger 13b extruded through a hole 21 produced independently of the entrance 9, thereby supporting the lower end 10a of the shutter 10.

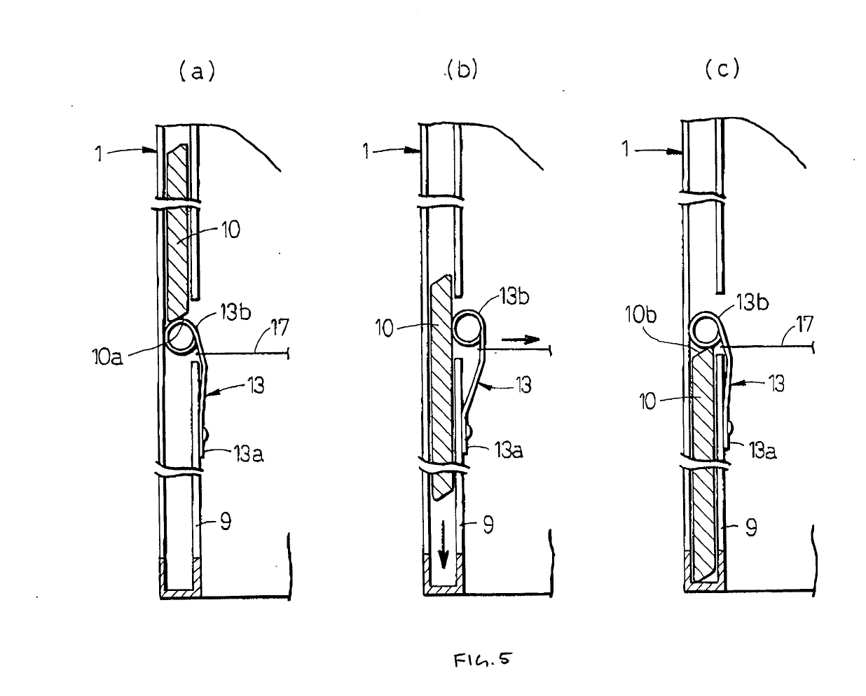

FIG. 5 shows a ring-shaped trigger 13b. In FIG. 5(a) the trigger 10b is engaged with the lower end 10a to support the shutter 10. When the trigger 13b is pulled by the connecting line 17 in the direction indicated by the arrow, it is disengaged with the shutter 10 as shown in FIG. 5(b). Then, as shown in FIG. 5(c), the shutter 10 drops by its own weight and closes the entrance 9.

At this moment, the trigger 13b returns to the position where it prevents the shutter 10 from inadvertently rising, thereby keeping the entrance 9 closed by a sufficient force to prevent the entrance 9 from being opened.

In order to carry out the fourth step (the repetitive step), several trapping devices are used, wherein they are structurally the same as those used before, but they are of different size and shape, and of different material in view of the fact that mice have an instinct for avoiding the same trapping device as used before.

### Experiment (1)

Experiment (1) was conducted under an agreement to preserve secrecy between the inventor and the tenant. The results obtained are summarized below in Table 1.

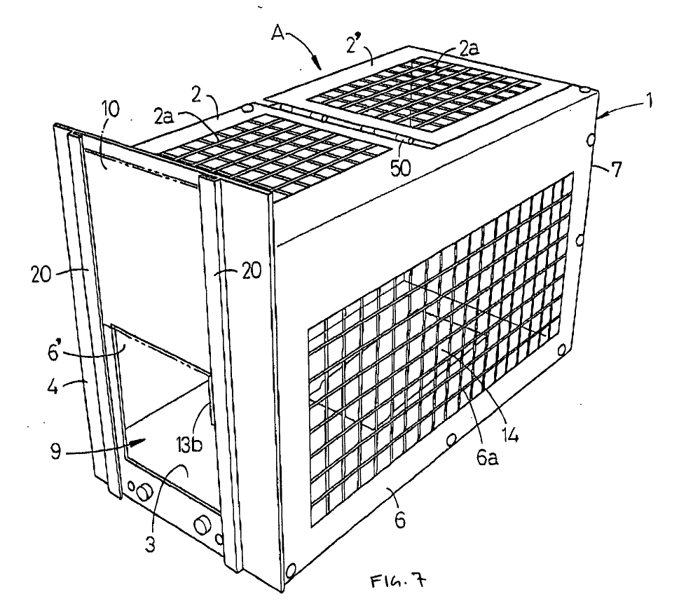

TABLE 1

| | |
|---|---|
| Place | a pub restaurant located in Osaka, Japan (the |
| | floor area was about 200 m²) |
| Time | from October 5, 1999 to January 31, 2000 (118 |
| | days including preparatory days) |
| Used | a total of 40 trapping devices were used. |
| Number | |
| Caught | a total of 42 mice (eighteen adults and twenty- |
| mice | four young mice). |
| Type of | (A) to (E) shown in FIGS. 7 to 11. |
| Trapping | |
| Device | |
| Used | |

Referring to FIGS. 7 to 11, further modified trapping devices will be described.

The trapping device (A) (hereinafter, Type (A)) shown in FIG. 7 is provided with a shutter 10 of the same type shown in FIGS. 3 and 4, characterized by the guide grooves 20 produced in the side 4 of the cage 1 along which the shutter 10 slides. The side 4 having the entrance 9, the opposite side 5, one of the pair of sides 6 and 6′, and the floor 3 are made of wood. The ceiling 2 and the other side 6 (or 6′) are made of metal, and are provided with metal lattice works 2a and 6a. Preferably, half of the ceiling 21 is joined by a hinge 50 so that the trapped mouse can be taken out. This modified embodiment also has a trigger 13b of a spring 13 and a board 14.

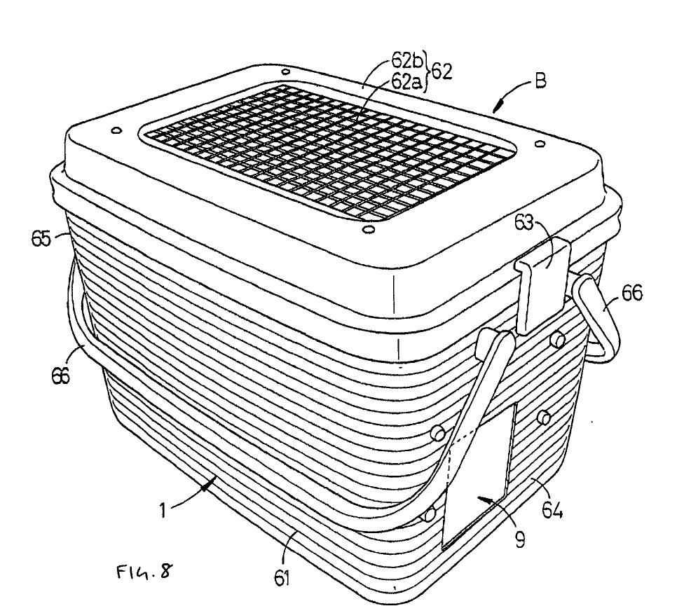

The trapping device (B) (hereinafter, Type (B)) shown in FIG. 8 has a cage 1 which comprises a body 61 of semi-transparent plastics and a lid 62. The body 62 is provided with a rectangular entrance 9 in one of the end faces 64 and 65. The lid 62 includes a lattice work portion 62a and a periphery 62b. The lid 62 is normally locked by locks 63. To place bait in the cage 1, and take out the trapped mouse, the lid 62 is removed by unfastening the locks 63. The cage 1 is provided with handles 66. The trapping device (B) is provided with a trigger mechanism of the type shown in FIGS. 3 and 4, wherein, however, the shutter 10 is constructed to slide along the guide groove formed in the inner side of the body 61.

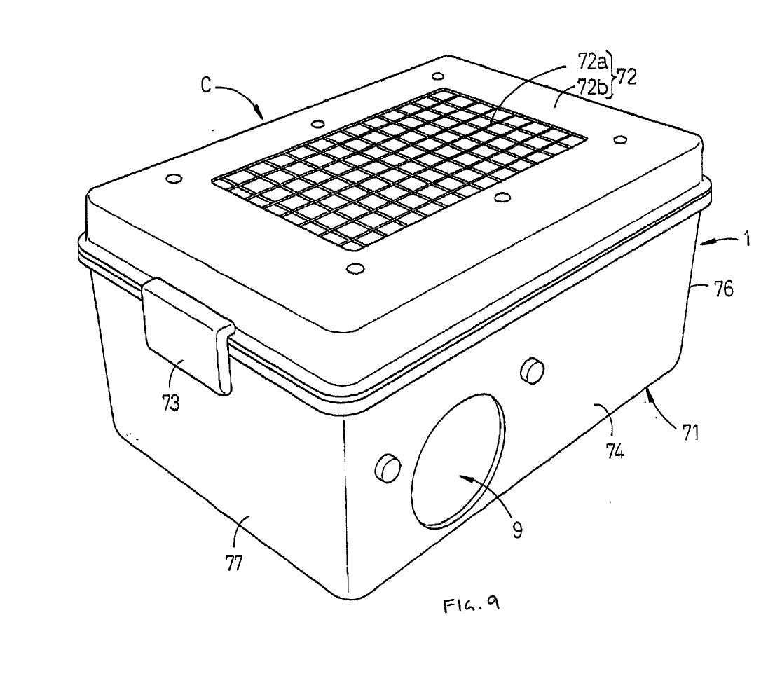

The trapping device (C) (hereinafter, Type (C)) shown in FIG. 9 has a cage 1 which consists of a body 71 of semi-transparent plastics, and a lid 72. One of the longitudinal sides 74 is provided with a circular entrance 9. The lid 72 is normally locked to the body 71 by means of locks 73. The lid 72 includes a lattice work portion 72a and a periphery 72b of colored plastics. When bait is placed in the cage 1, or a trapped mouse is taken out, the lid 72 is removed by unfastening the locks 73. The shutter 10 is the same as that shown in FIG. 5, wherein, however, the shutter 10 is provided in the inner side of the side 74 in which the entrance 9 is provided.

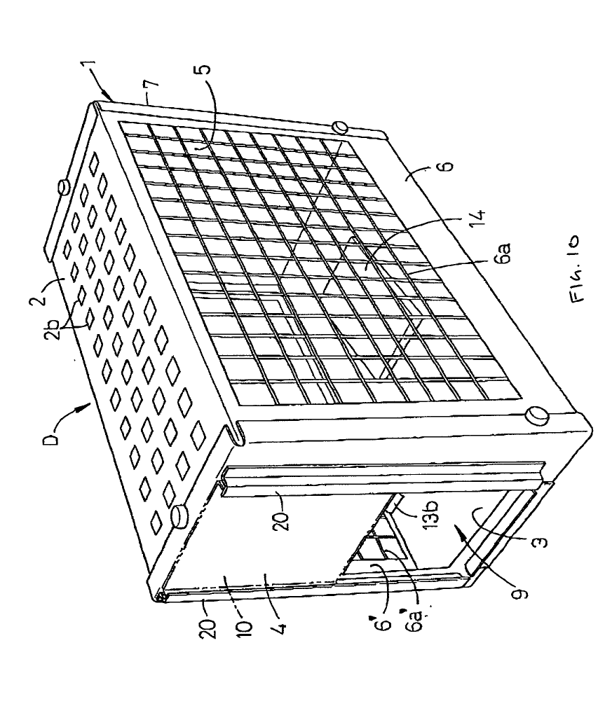

The trapping device (D) (hereinafter, Type (D)) shown in FIG. 10 has a shutter 10 of the same type shown in FIGS.-3 and 4. Likewise, the shutter 100 slides along the vertical guide grooves 20. The floor 3 of the cage 1 is made of wood, and the other sides 5, 6, and 6′ are of metal. The opposite sides 6 and 6′ are provided with metal lattice works 6a and 6a′, and the ceiling 2 is provided with pores 2b. The reference numeral 13b and 14 denote a trigger and a board, respectively.

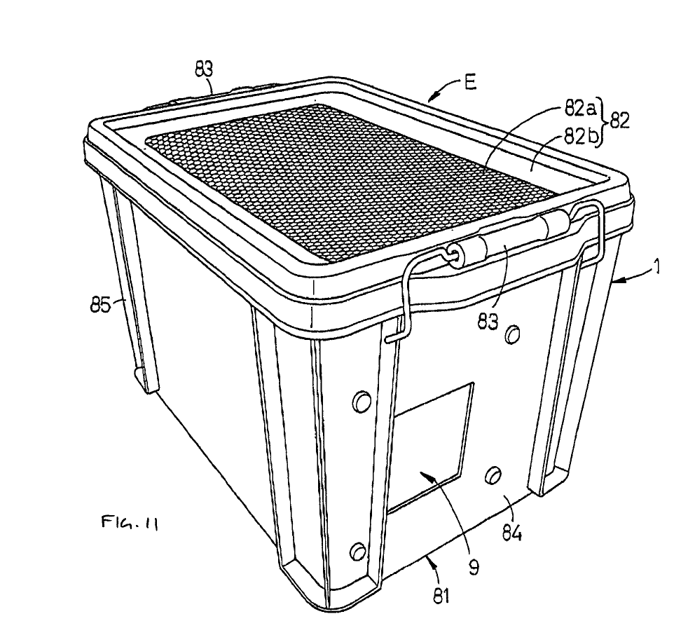

The trapping device (E) (hereinafter, Type (E)) shown in FIG. 11 has a cage 1 which consists of a body 81 of colored plastics and a lid 82. One of the sides (in the illustrated embodiment, the side 84) is provided with a rectangular entrance 9. The reference numeral 83 denotes a pair of locks for fastening the lid 82. The lid 82 includes a metal lattice portion 82a and a periphery 82b of colored plastics. The trapping device (E) is provided with the same trigger mechanism as that shown in FIG. 5.

### The Process of the Experiment

This experiment consisted of four trapping trials conducted at intervals of a few days. Each time the type of device was changed in size, material, shape, structure, etc. so as to prevent mice from learning about trapping. It is found out that if the shape, material, size, etc are changed, the knowledge a mouse previously got from the trapping device is not effective against the new version.

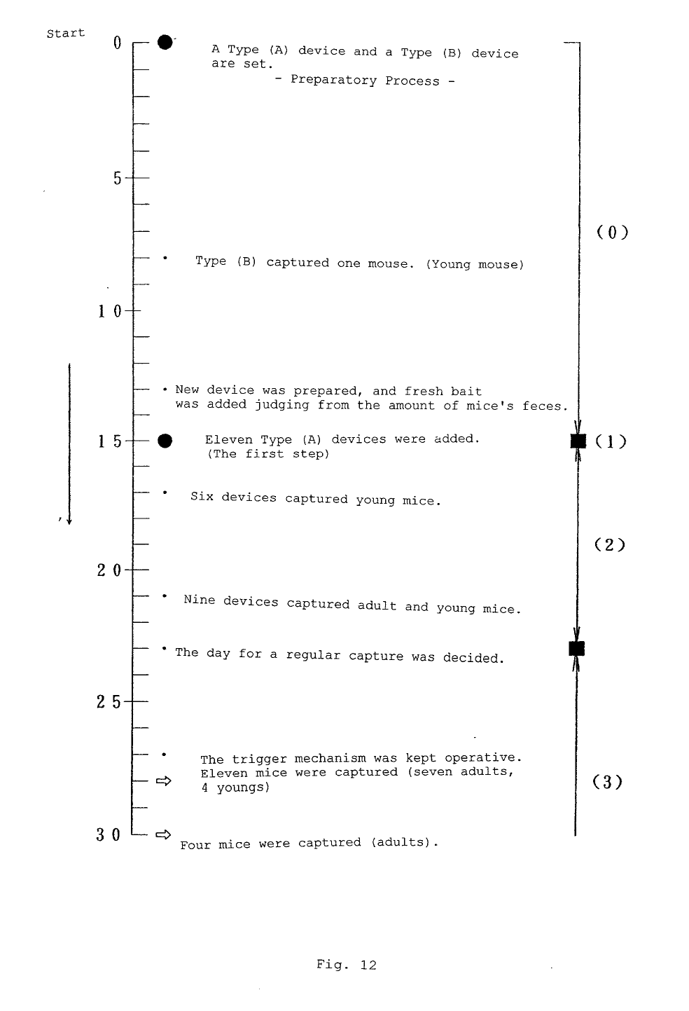

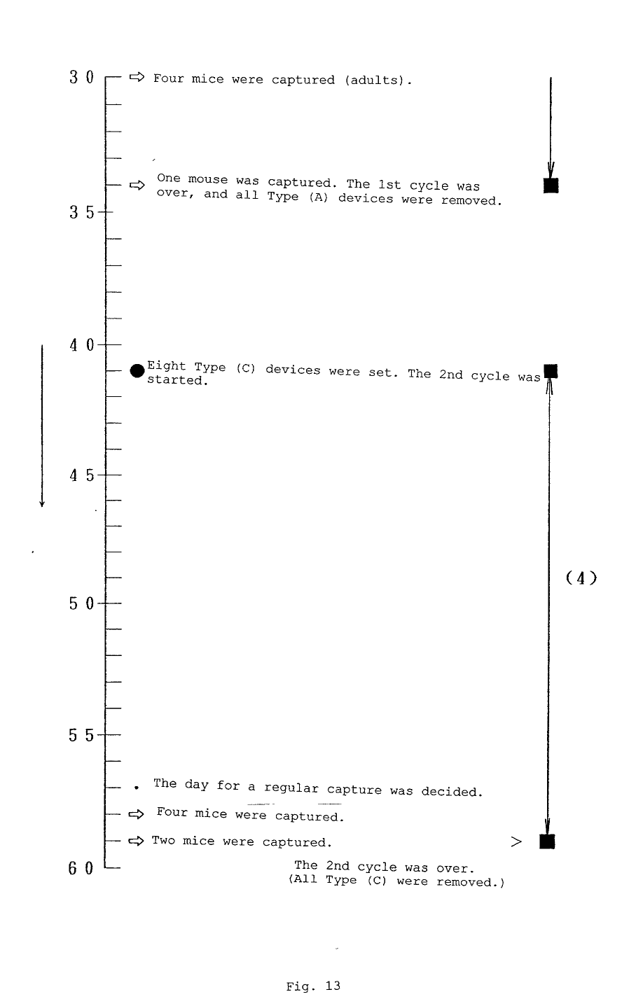

The experiment was conducted according to the schedule shown in FIGS. 12 to 15. The process of experiment will be described step by step.

(0) Preparation

In order to know what bait would be liked by mice living in a particular building, the trapping device Type (A) (FIG. 7) and Type (B) (FIG. 8) were set under a kitchen range with a lot of bait scattering on the floor in the cage, wherein each trigger was kept inoperative or removed (that is, the doors open). The bait included sunflower seeds, chaff, millet, rice, dog food, and pigeon food.

For seven days following the day when the research began, the devices were checked to see how frequently mice visited the cages and ate the bait. Thereafter the trigger was set in each of the devices. On the eighth day, house mice (young mice) were captured in the Type (B) device. The device Type (B) was removed, and the Type (A) device was left as it was.

On the 13^{th} day an analysis was conducted to see what kind of bait was most popular. And, the number of the visiting mice was estimated from the degree of reduction in bait, and from the quality of mouse feces scattered on the floor. Based upon the data obtained through the research, eleven Type (A) devices were set after fresh bait was added. The number ‘eleven’ was decided in accordance with the estimated number of mice and the space allowing the devices to be set (the kitchen had a limited space)

(1) The First Step (starting to capture mice)

On the 15^{th} day the prepared eleven Type (A) devices were set with the triggers removed, and with a lot of bait scattering on the floor in the cage. They were placed under the same kitchen range in the same pub restaurant.

(2) The Second Step

Every day after the Type (A) devices were set, the cages were inspected to determine the reduction of bait. Fresh bait was added as necessary to feed the visiting mice, and to encourage an increase in the number of visiting mice. The important thing here is not to capture the mice immediately but to feed the mice and, by waiting, draw more mice to the baited cages. On the 17^{th} day (the 2^{nd} day from the setting of the fresh group of devices) it was observed from mice's feces that six devices were visited by young mice.

(3) The Third Step

For a few days the inspection was continued, and nine cages were found to be visited by mice. It was concluded that no further inspection would be necessary, and it was decided that capture should be started within a few days by using all the Type (A) devices already set. The total number of devices was 12, and the visited devices were 9; therefore, the ratio of 9 to 12 (or 3 to 4) was established.

On the 27^{th} day, each of the twelve Type (A) devices was equipped with the trigger mechanism (shutter 10) mentioned above, and the regular capture was carried out in response to the movement of the board by a visiting mouse.

On the 28^{th} day from the start eleven mice were captured (seven adult mice and four young mice). They were taken out of the cages, and confined in separate containers. The used devices were cleaned with cloth, and after being supplemented with fresh bait, they were set in place. Two days later (the 30^{th} day from the start of preparation), an additional four adult mice were captured, and six days later (34^{th} day from the start of preparation) one mouse was captured, wherein the bait had been replenished.

Only one mouse was captured on the 34^{th} day from the start, and the first capture process was finished. All the Type (A) devices were removed, and the appearance of mice was monitored. In the days which followed, no mouse visited that area, but a week or so later it was again visited by mice. It was understood that they came back to their homes, or they migrated from other places.

(4) The Fourth Step (2^{nd} cycle of capture process)

A week after the first step was practiced, that is, on the 41^{st} day capture was initiated by using eight Type (C) devices (FIG. 9) in the same manner as the first step. The number of cages was decided by referring to the amount of mouse feces scattered about. In the following few days the same process was practiced, and on the 59^{th} day all the Type (C) devices were removed. In this way the second step was over after 6 mice were captured.

(5) The Fifth Step (3^{rd} cycle of capture process)

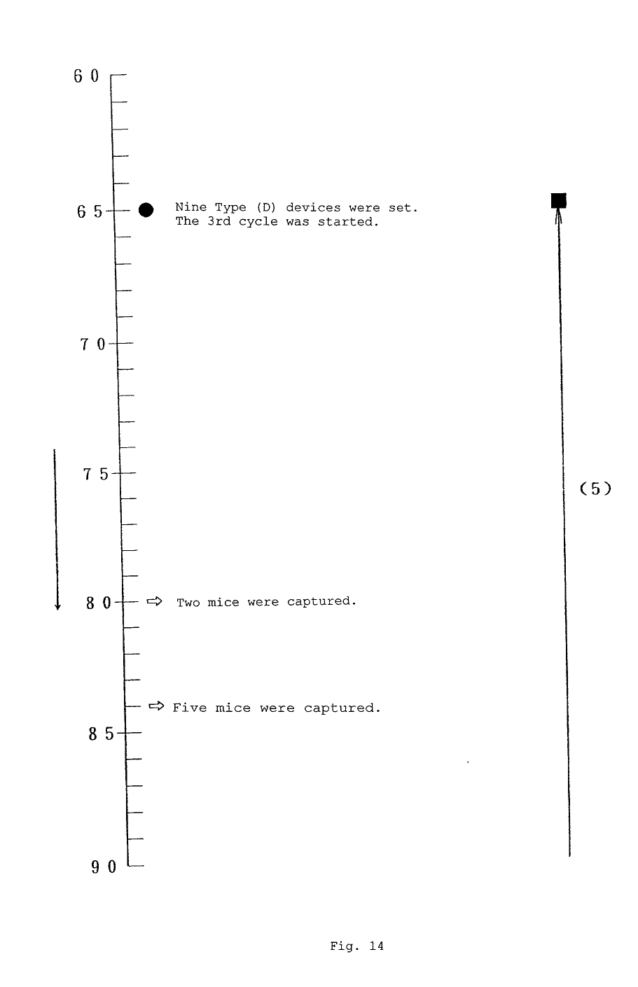

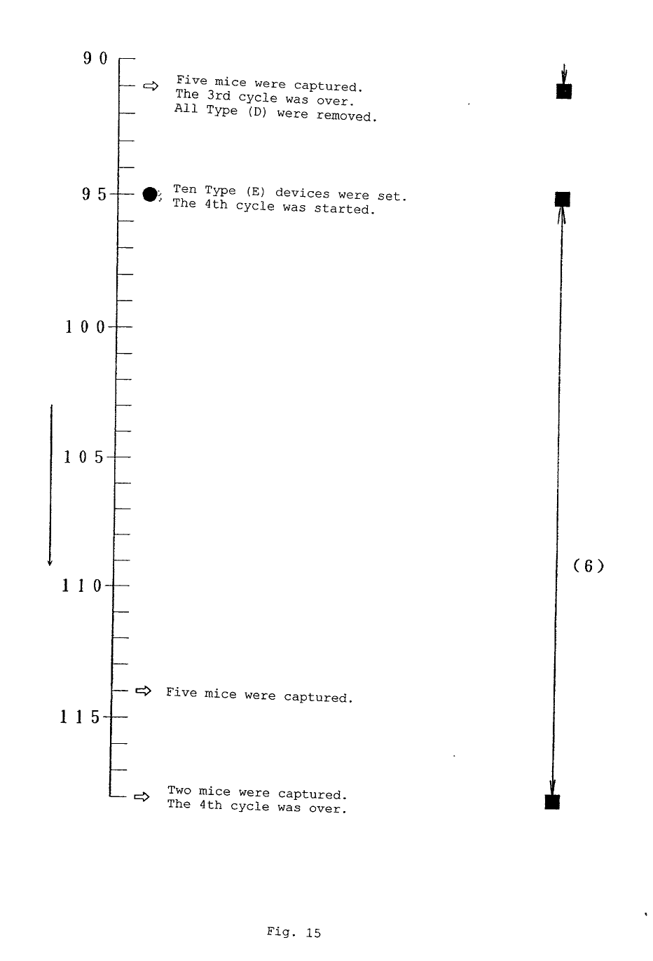

On the 6^{th} day from the finish of the second step (65^{th} day from the start), the 3^{rd} cycle was started, and about a month later (91^{st} day from the start) the step was finished (refer to FIGS. 14 and 15). In the third step nine Type (D) devices were used, and twelve mice were captured in the same manner as that used in the first and second cycles.

(6) The Sixth Step (4^{th} cycle of capture process)

On the 4^{th} day from the end of the 3^{rd} cycle (95^{th} day from the start) the 4^{th} cycle was initiated. Three weeks later 118^{th} day from the start) the 4^{th} cycle was finished (FIG. 15). In this step ten Type (E) devices (FIG. 11) were used, and seven mice were captured. The process was followed in the same manner as that in the 1^{st} and 2^{nd} cycle.

After the 4^{th} cycle was finished, ten trapping devices of another type were set for precaution, but there was a trace of only one or two mice visiting them. This demonstrates that almost all mice living in that area were captured. It was ascertained that the process of capture was equally effective irrespective of species of mouse.

### Advantages of the Invention

The method of capturing mice according to the present invention is characterized in that mice visiting the baited cages are fed until they feel safe in the cage as if they stay in their homes. As a result, more mice come to the trapping devices. When they gather in number, the shutters (doors) are triggered to confine them in the cage. The capturing processes are repeated cycle by cycle as required, during which uncaptured mice and newcomers are captured when they come back to their homes or new abodes. The trigger mechanism is designed to set off in response to even a light movement of the board caused by mice which step thereon.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for capturing mice with a baited cage incorporating a trigger mechanism whereby the captive is confined in the cage, the method comprising the steps of:
(1) placing a plurality of baited cages in place with a trigger mechanism kept inoperative;
(2) inspecting the conditions of the bait eaten by mice at a predetermined time intervals, and adding at least one baited cage having a similar structure to that used in the first step;
(3) repeating the second step at least until the numerical ratio of the haunted cages (B) to the initially set cages (A) reaches a predetermined value, then disengaging the trigger mechanism of each trapping device; and
(4) repeating the steps (1) to (3) at least one time with a different type of trapping device employed in the last cycle of steps (1) to (3).

2. The method according to claim 1, wherein the step (3) comprises repeating the second steps for a predetermined period of time at least until no more mice eat the bait in each of the cages, and then making all the trigger mechanisms operative so as to start a regular capture process.

3. The method according to claim 1, wherein the trapping device comprises:
a cage having an entrance through which a mouse enter it;
a spring-biased trigger mechanism comprising a shutter released by a visiting mouse, thereby closing the entrance with captive confined in the cage; and a board located in the cage for a mouse to step on, the board being connected to the trigger mechanism.

4. The method according to claim 2, wherein the trapping device comprises:
a cage having an entrance through which a mouse enter it;
a spring-biased trigger mechanism comprising a shutter released by a visiting mouse, thereby closing the entrance with captive confined in the cage; and a board located in the cage for a mouse to step on, the board being connected to the trigger mechanism.

5. A method for capturing rodents, comprising the acts of:
(a) providing a plurality of cages of a first configuration, wherein the cages contain rodent bait and wherein the cages include a trigger mechanism for closing an entrance to the trap, wherein the trigger mechanism is placed in an inoperative condition;
(b) at predetermined time intervals, determining whether rodents have visited the plurality of baited cages, and adding at least one baited cage;
(c) repeating act (b) at least until a numerical ratio of the number of baited cages visited by at least one rodent to the number of baited cages initially set reaches a predetermined value, then placing the trigger mechanism of each baited cage in operative condition; and
(d) repeating acts (a)-(c) at least one time, wherein in each successive iteration baited cages of a different configuration are used.

6. The method of claim 5, further comprising in act (c) the removal and disposal of any captured rodents.

7. The method of claim 5, further comprising in act (b), determining the visitation of rodents by visually inspecting the bait of each baited cage.

8. The method of claim 5, further comprising in act (b), determining the visitation of rodents by visually inspecting in and around each cage for rodent feces.

9. The method of claim 5, further comprising in act (d), placing the trigger mechanisms of all baited cages in operative condition for a regular capture process.

10. The method of claim 5, wherein act (c) instead comprises repeating act (b) for a predetermined period of time, at least until it is determined that rodents are no longer visiting every baited cage, then placing the trigger mechanism of each baited cage in operative condition.

11. The method of claim 5, further comprising in act (c) the removal and disposal of any captured rodents.

12. The method of claim 5, further comprising in act (b), determining the visitation of rodents by visually inspecting the bait of each baited cage.

13. The method of claim 5, further comprising in act (b), determining the visitation of rodents by visually inspecting in and around each cage for rodent feces.

14. The method of claim 5, further comprising in act (d), placing the trigger mechanisms of all baited cages in operative condition for a regular capture process.

15. A method for capturing rodents, comprising setting a plurality of baited rodent traps in inoperative condition at least near a rodent infestation site;
determining that rodents are visiting the baited rodent traps;
placing the rodent traps in operative condition for trapping rodents;
removing and disposing of any captured rodents in the traps; and
repeating, in iterative fashion, for at least one cycle, the above four acts with baited rodent traps of different configurations.

16. The method of claim 15, wherein the rodent traps comprise a cage having an entrance through which a rodent may enter and a spring-biased trigger mechanism which when triggered by a rodent in the trap closes the entrance to the trap, thereby confining the rodent.

17. The method of claim 15, wherein the trigger mechanism of the rodent trap is operatively connected to a pivotable board which, when stepped on by a rodent, triggers the trigger mechanism.

18. The method of claim 15, wherein baited rodent traps are constructed of a material selected from the group consisting of metal, metal lattice, plastic, wood, paper, cloth, or any combination thereof.

19. The method of claim 15, wherein the trigger mechanism of each baited rodent trap is not placed in operative condition until after a determination that the rodents are freely visiting the baited traps.

20. A kit of rodent traps for capturing rodents using iterative deployment of live rodent traps with differing characteristics, the kit comprising:
a first group comprising at least one rodent trap for capturing live rodents, the at least one first-group rodent trap having a first set of physical characteristics, wherein the at least one first-group rodent trap may be temporarily disarmed from capturing rodents; and
a second group of at least one rodent trap for capturing live rodents, the at least one second-group rodent trap having a second set of physical characteristics, wherein the at least one second-group rodent trap may be temporarily disarmed from capturing rodents;
wherein the second set of physical characteristics is sufficiently different from the first set of characteristics that rodents conditioned to avoid the at least one first-group rodent trap having the first set of physical characteristics will not avoid the at least one second-group rodent trap having the second set of characteristics.

21. The kit of claim 20, wherein the first set of physical characteristics comprises at least one characteristic selected from the group consisting of color, shape, entrance location, trigger mechanism, rodent trap materials.

22. The kit of claim 20, wherein the second set of physical characteristics comprises at least one characteristic selected from the group consisting of color, shape, entrance location, trigger mechanism, rodent trap materials.
